(19) United States
(12) Patent Application Publication
(10) Pub. No.: US 2018/0365023 A1
(43) Pub. Date: Dec. 20, 2018

(54) TEASER OF AN APPLICATION AVAILABLE FOR INSTALLATION

(71) Applicant: MacPaw Inc., Santa Clara, CA (US)

(72) Inventor: Oleksandr KOSOVAN, Kiev (UA)

(73) Assignee: MacPaw Inc.

(21) Appl. No.: 15/624,671

(22) Filed: Jun. 15, 2017

(51) Int. Cl. G06F 9/445; G06F 9/44

(52) U.S. Cl. CPC G06F 9/445; G06F 8/65; G06F 9/4443; G06F 8/61

(57) ABSTRACT

A teaser of an application for displaying information about an application available for installation on an electronic device includes: application metadata retrieved from a storage of the electronic device; a window configured to provide the application metadata retrieved from the storage in at least one of textual and graphical format on an output device; and an interface control provided in the teaser of the application, the interface control configured to sequentially start download, validation, installation, and launch of the application available for installation provided in the teaser of the application.

### BACKGROUND

### Technical Field

Aspects of the present disclosure relate to a user interface component providing preview capabilities, and more particularly to a method of previewing and installing applications on an electronic device.

### Related Art

As the number of applications is growing, finding a desired application has become a challenge. When a user needs to find an application for opening a particular file type or performing a certain function, they have to go through selection, purchase, download, and installation procedures before actually launching some application. This approach can be time- and resource-consuming, especially when the user is not sure about capabilities and quality of an application. Sometimes, an application has to be downloaded and configured, only for the user to discover that the application does not match the user's current needs. In this case, the user will be forced to resume the search for a suitable application.

Therefore, the user experience could be substantially improved with the possibility of previewing an application before starting the whole installation and configuration process. Moreover, the process from the selection of an application to its launch could be shortened.

### SUMMARY

Systems and methods for previewing and installing applications available for installation on an electronic device are provided.

According to various aspects there is provided a teaser of an application for displaying information about an application available for installation on an electronic device. In some aspects, the teaser of an application may include: application metadata retrieved from a storage of the electronic device; a window configured to provide the application metadata retrieved from the storage in at least one of textual and graphical format on an output device; and an interface control provided in the teaser of the application, the interface control configured to sequentially start download, validation, installation, and launch of the application available for installation provided in the teaser of the application.

According to various aspects there is provided a method for previewing and launching an application available for installation on an electronic device. In some aspects, the method may include: receiving via an interface a request to provide a teaser of the application having application metadata stored in a storage on the electronic device; contacting, by the electronic device, a server to determine whether updates are available for the application metadata; in response to determining that updates are available for the application metadata, downloading updated application metadata from the server and updating the application metadata stored on the electronic device; generating the teaser of the application based on the updated application metadata in the window on the display; receiving via the interface a request to launch the application provided in the teaser of the application; requesting from the server by the electronic device an application installation file corresponding to the application of the teaser of the application; receiving from the server the requested application installation file; installing the application on the electronic device; launching the installed application; and closing the teaser of the application after launching of the installed application.

According to various aspects there is provided a non-transitory computer readable medium. In some aspects, the non-transitory computer readable medium may include instructions for causing one or more processors to perform operations including: storing in a storage of an electronic device metadata of an application available for installation on the electronic device; providing at least one teaser icon of the application available for installation on the electronic device at a location on a display of the electronic device where icons of installed applications are provided; receiving via an interface a request to provide a teaser of an application having application metadata stored in the storage on the electronic device; contacting, by the electronic device, a server to determine whether updates are available for the application metadata; in response to determining that updates are available for the application metadata, downloading updated application metadata from the server and updating the application metadata on the electronic device; generating the teaser of the application based on the updated metadata in the window on the display; receiving via the interface a request to launch the application provided in the teaser of the application; requesting from the server by the electronic device an application installation file corresponding to the application of the teaser of the application; receiving from the server the requested application installation file of the application; installing the application on the electronic device; launching the installed application; and closing the teaser of the application after launching of the installed application.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1 is a screenshot of an exemplary teaser of an application displayed in a window in accordance with various aspects of the present disclosure;

FIG. 2 is a block diagram illustrating an application distribution environment in accordance with various aspects of the present disclosure;

FIG. 3 is a flowchart illustrating a method for opening a teaser of an application in accordance with various aspects of the present disclosure;

FIG. 4 is a flowchart illustrating a method for launching an application from a teaser of an application in accordance with various aspects of the present disclosure;

FIG. 5 is a flowchart illustrating a method for opening a file in an application that is launched from a teaser of an application in accordance with various aspects of the present disclosure; and

FIG. 6 is a block diagram illustrating an example computing environment with an example computing device associated with the application distribution environment in accordance with various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

In accordance with various aspects of the present disclosure, a teaser of an application allows a user to preview an application on the user's electronic device without download and installation. Applications are already available in evident locations on the user's device after installation of application management software. The information provided in the teaser is enough for the user to form an initial estimate regarding value and quality of the application, and may overcome challenges of the conventional selection process, reduce time spent on surfing the Internet, reading feedback, and deciding on the application. Purchase, download, installation, and configuration processes may be streamlined and virtually aggregated in a single automatic process initiated with one action (for example, a click on a button). Therefore, the user experience may be substantially improved with the ability to preview an application before starting an installation and configuration process.

A teaser of an application is a user interface element that relates to a method of previewing an application available for installation on an electronic device. Unlike conventional methods, the teaser of an application allows a user to preview an application on an electronic device without download and installation. Also, the teaser of an application allows the user to open the application with a single action (for example, a click on a button).

Aspects of the present disclosure provide a method of previewing an application that is available for installation on an electronic device. In accordance with aspects of the present disclosure, a user interface component (hereinafter a “teaser of an application”) may be provided that displays essential information on the application available for installation on the electronic device and allows a user to open the previewed application after it was silently downloaded and installed. Alternative implementations of the invention may include functionality for in-app purchases or an embedded store where a user can quickly purchase a license of the previewed application.

The aspects of the present disclosure may be implemented as part of an application distribution environment, where teasers of applications are managed by application management software installed on a user's electronic device. In alternative implementations, teasers of applications may function as stand-alone applications that directly communicate with a server that maintains metadata for the applications available for installation, and performs one or more of the operations.

Icons of the teasers of applications (hereinafter referred to as “teaser icons”) may be displayed in evident locations on the user's device after installation of the application management software. A teaser icon may appear as an icon of an original application it represents but unlike a regular application icon the teaser icon invokes a teaser of an application.

A teaser of an application represents metadata of an original application in a preview window of a strict unified pattern, i.e., a teaser of an application (preview window) may have the same design as well as metadata types and structure of metadata for every application. Thus, teasers of applications for every application will have the same appearance. Metadata displayed in application teasers may be of textual, graphical, and/or video format, and may be provided by the developer of the application. In particular, a teaser of an application may include, but is not limited to, an application name, version, release date, system requirements, brief description of capabilities, application motto, screenshots, video files, and/or valuable URLs. Generally, this information is sufficient for a user to form an initial estimate regarding value and quality of the application. Thus, the systems and methods of the present disclosure overcome challenges of the conventional selection process and reduce time spent by a user surfing the Internet, reading feedback, and making a decision on the application.

In accordance with various aspects of the present disclosure, a teaser of an application may include a user interface control (hereinafter referred to as the “Open button,” but not limited thereto). The Open button may initiate download, installation, and basic configuration of the original application represented by the teaser of the application. These processes may be transparent to the user and may be started automatically. Alternative implementations may include an embedded store or functionality that enables in-app purchases. Thus, various aspects may streamline purchase, download, installation, and configuration processes and virtually aggregate them in a single automatic process initiated with one action (for example, a click on a button).

Aspects of the present disclosure may serve as an intermediary between an operating system (OS) of the electronic device, for example, but not limited to, macOS, iOS, or Android, and the user who has no applications for opening a particular file type. The operating system of the device may retrieve information about supported file formats from application teaser preference files and use the information to open a teaser of an application matching the user's needs. For example, when the user tries to open a pdf file but none of the applications installed on the device can open a pdf file, the system may reveal a teaser of an application corresponding to an application that supports a pdf file type. Clicking on the Open button of the teaser of the application will open the file in the recommended application.

Compared to conventional methods, aspects of the present disclosure provide a convenient and resource-effective method of determining capabilities, value, and quality of applications available for installation on a user device.

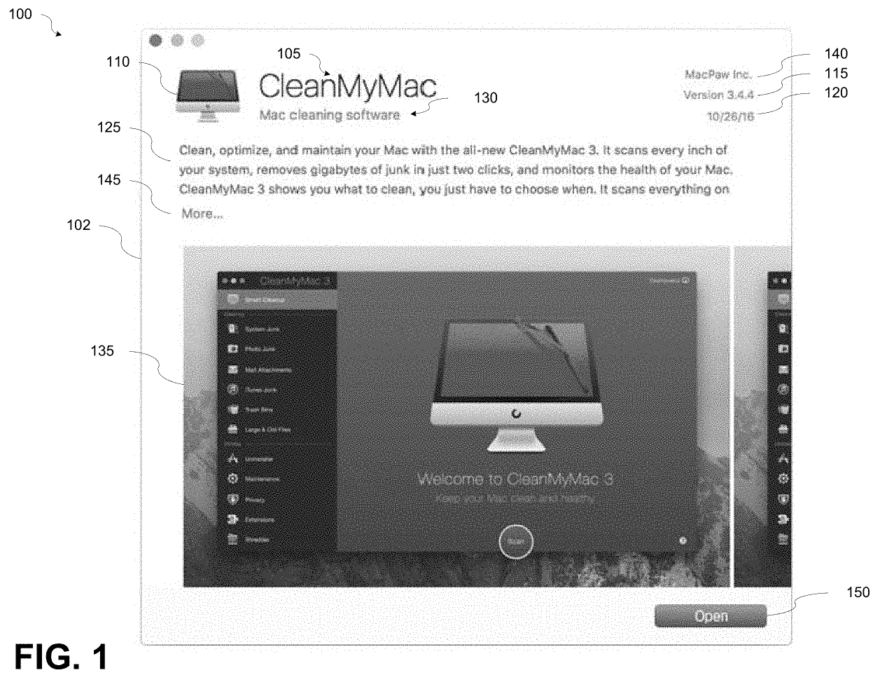

FIG. 1 is a screenshot of an exemplary teaser of an application 100 displayed in a window 102 in the macOS™ environment in accordance with various aspects of the present disclosure. One of ordinary skill in the art will appreciate that the various aspects of the present disclosure may be implemented within any environment or platform that is adapted to use on desktop computers, mobile devices, laptops, tablets, and other electronic devices supplied with graphical user interface without departing from the scope of the present disclosure.

The teaser of an application 100 is a preview of a generic pattern that includes customized metadata of a particular application. In accordance with various aspects of the present disclosure, metadata is provided by the developer of the application and thus is of the reliable origin. In accordance with various aspects of the present disclosure, metadata can be obtained from other sources of information and stored in locations that differ from those described herein.

Metadata used in the teaser of an application 100 may be of any appropriate format. For example, textual, graphical, or video. Referring to FIG. 1, the screenshot of the teaser of an application 100 may include, but is not limited to, the following metadata:
application name 105;
application icon 110;
application version 115;
date of the release of the current version 120;
brief description of application capabilities 125;
application motto 130;
screenshot of the application 135;
name of the developer 140; and
product web page URL (not shown).

The teaser of an application 100 may include some or all of the above-described metadata, as well as it may include any additional metadata that can be valuable to the user for making a decision on the reviewed application. In particular, the a teaser of an application 100 may also provide OS compatibility information, localization details, description of supported files formats, and any other application-related metadata.

Various aspects of the present disclosure may include a set of screenshots (at least one), interactive screenshots, video files, or other media files, which aim to give the user an overall picture of the application's design. If the teaser of an application 100 includes more than one screenshot 135, the screenshots may be displayed as a carousel of images that the user can scroll to view them all. According to various aspects of the present disclosure, a teaser of an application 100 may automatically change screenshots of the application, or it can use any other method of representing screenshots and video files.

In accordance with various aspects of the present disclosure, a description of the application's intended use and capabilities may be displayed in the progressive disclosure form 145 for the user's convenience. In accordance with various aspects of the present disclosure, the name of the developer 140 may be displayed as a link to a product web page, support page, software developer website, or else.

One of ordinary skill in the art will appreciate that the application metadata represented in the teaser of an application 100 may be grouped and displayed in any appropriate form and order that is convenient for the user without departing from the scope of the present disclosure. The user can select to preview any number of applications that can be displayed in separate windows, or in any other way. All previewed applications may be grouped in one window under their tabs.

If the user decides to install the previewed application, the user may command the teaser of the application 100 to install the application. For this purpose, the teaser of an application 100 may include a user interface control, for example, but not limited to, an Open button 150. The Open button 150 may sequentially initiate download, installation, and launch of the previewed application. One of ordinary skill in the art will appreciate that the Open button 150 is only one of many possible implementations of a user interface control that can initiate the described processes without departing from the scope of the present disclosure. Thus, download, installation, and launch of the application may be performed sequentially and automatically after using the described user interface control (i.e., the Open button 150).

In accordance with various aspects of the present disclosure, download, installation, and launch of the previewed application may be triggered with a single request and then performed automatically. In accordance with various aspects of the present disclosure, the Open button 150 may also initiate a validation process that checks if a downloaded application is received from a trusted developer (e.g., it may check the code signature of the application).

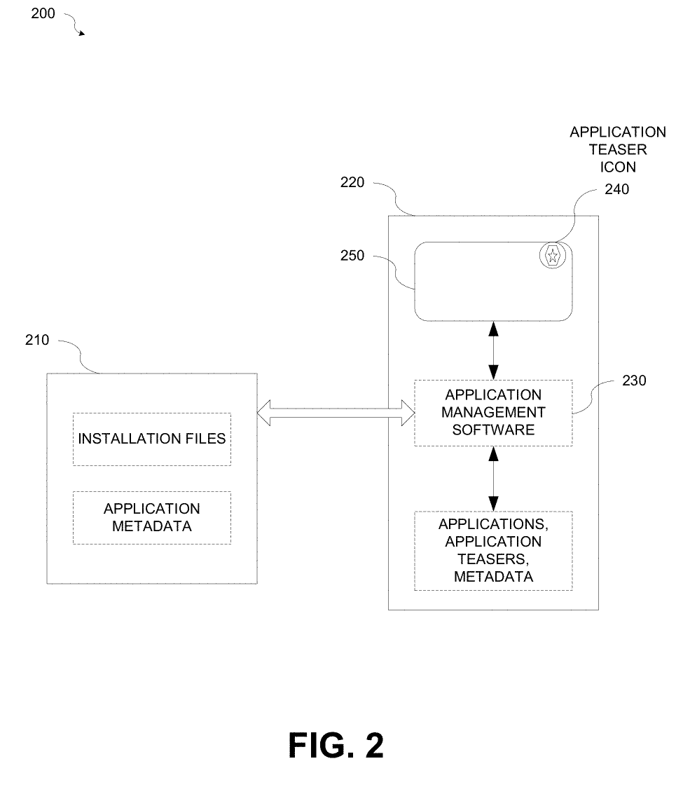

Aspects of the present disclosure may be implemented as part of an application distribution environment. FIG. 2 is a block diagram illustrating an application distribution environment 200 in accordance with various aspects of the present disclosure. Referring to FIG. 2, the application distribution environment 200 may include a server 210 configured to maintain installation files and application metadata. The installation files and application metadata may be provided by developers of the applications. The application distribution environment 200 may further include an application management software 230 (hereinafter ‘app management software’) that is installed on an electronic device 220 of a user. The app management software 230 may communicate with the server 210 to manage installation and update of teasers of applications, applications, and their metadata on the user's electronic device 220.

In accordance with various aspects of the present disclosure, teasers of applications may function as stand-alone applications that directly communicate with a server.

When the application management software 230 is installed, at least one teaser icon 240 of an application that is available for installation on the electronic device 220 appears in one or more evident locations on a display 250 of the electronic device. For example, if the app management software 230 is installed on a computer with the macOS™ operating system, teaser icons may appear in Launchpad, in a dedicated folder on the Dock and in a separate folder among Finder®Favorites. In accordance with various aspects of the present disclosure, the user may wish to search for a particular application that is available for installation on the electronic device 220 by its name or supported file format. The user may search using the internal search functionality of the electronic device 220. For example, in case of the implementation into a macOS™ computer, the teaser of an application may be invoked using the Spotlight search.

A teaser icon 240 may look like an icon of the original application it represents. In accordance with various aspects of the present disclosure, the teaser icon 240 may slightly differ from the original application icon, for example in some indicia in the corner of the icon or in any other appropriate way as would be understood by those skilled in the art.

The user may open the teaser of an application using any suitable approach, including, for example, but not limited to, double-clicking or clicking on the teaser icon 240, choosing a corresponding command from a shortcut menu of the teaser icon 240, hovering over the teaser icon 240, and/or executing an internal search within the electronic device 220.

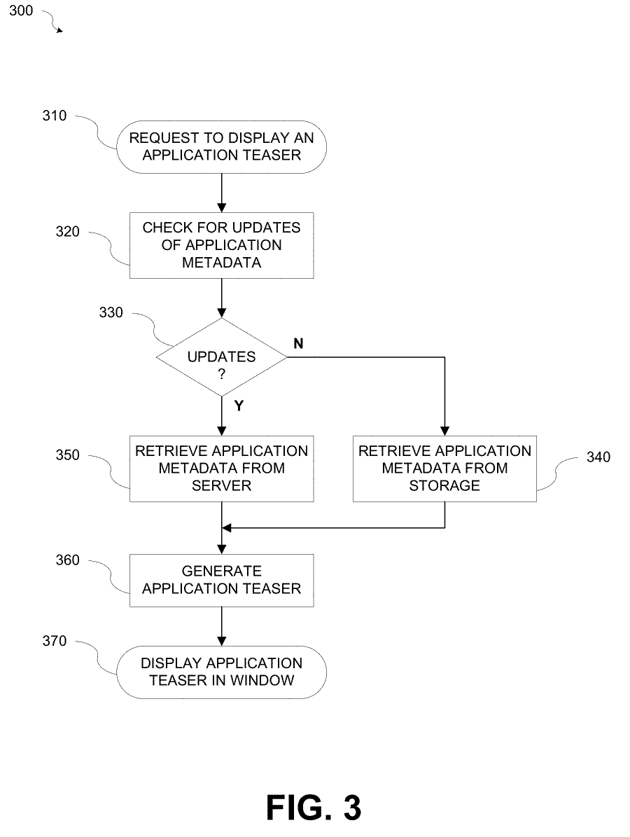

FIG. 3 is a flowchart illustrating a method 300 for opening a teaser of an application in accordance with various aspects of the present disclosure. Referring to FIGS. 1-3, at block 310, the application management software 230 may receive a request to display a teaser of an application. After receiving the request, at block 320 the application management software 230 may send a request to the server 210 to check for the updates of the application metadata. At block 330, the server 210 may determine whether updates of the application metadata are available. In response to determining that updates are not available (330—N), at block 340 the app management software 230 may retrieve application metadata from local storage of the user electronic device 220. In response to determining that updates are available (330—Y), at block 350 the app management software 230 may retrieve application metadata from the server 210. At block 360, the app management software 230 may generate a teaser of an application 100. At block 370, the app management software 230 may display the teaser of an application 100 in the window 102 on the display 250 of the electronic device 220.

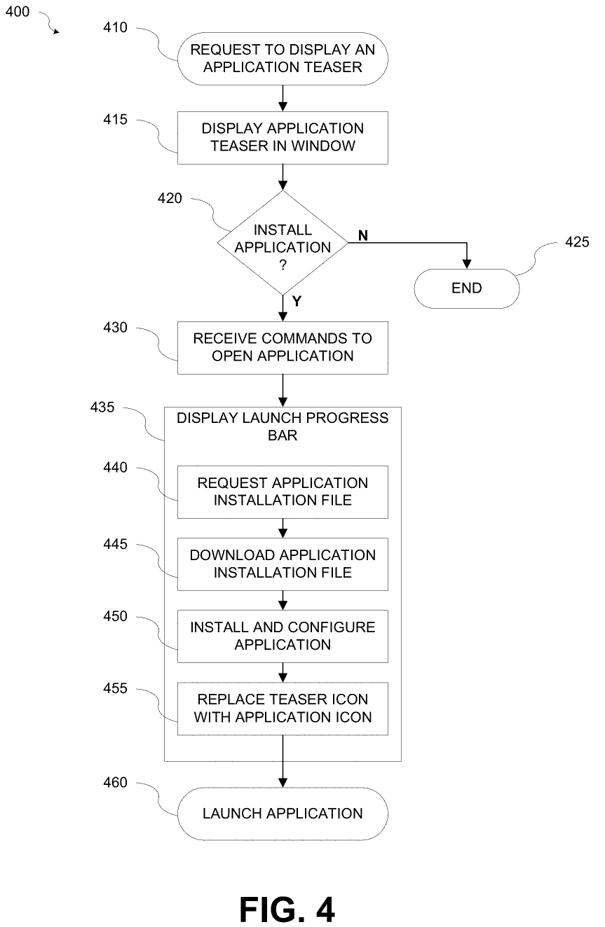

FIG. 4 is a flowchart illustrating a method 400 for launching an application from a teaser of an application in accordance with various aspects of the present disclosure. Referring to FIGS. 1, 2, and 4, at block 410, the app management software 230 may receive a request to display a teaser of an application 100. At block 415, the application management software 230 may display the teaser of an application 100 in the window 102 on the display 250 of the electronic device 220. At block 420, a user may determine whether to install the application previewed in the teaser of an application 100. In response to determining not to install the application previewed in the teaser of an application 100 (420—N), at block 425 the process ends.

In response to determining to install the application previewed in the teaser of an application 100 (420—Y), at block 430 the app management software 230 may receive commands to install the application. For example, the user may input a command (e.g., activate the Open button 150) on a user interface device of the electronic device 220. Download, installation, and launch of the application may be performed sequentially and automatically after using a prescribed user interface control (i.e., the Open button 150). At block 435, the teaser of an application 100 may display a progress indicator, for example, but not limited to a bar, indicating the progression of the launch process. In accordance with various aspects of the present disclosure, the progress indicator may remain displayed in the teaser of an application 100 until the application is opened. One of ordinary skill in the art will appreciate that the progress of download, installation, and/or launch process can be displayed in any other way without departing from the scope of the present disclosure. In accordance with various aspects of the present disclosure, when the user clicks the Open button 150, the Open button 150 may change to a Stop button, which the user may click to cancel the on-going process.

After receiving a request to install the application, at block 440 the app management software 230 may send a request to the server 210 to get the application installation file. At block 445, the installation file may be downloaded. For example, the app management software 230 may download the application installation file to the user electronic device 220 from the server 210. At block 450, the application may be installed and configured. For example, the app management software 230 may automatically start installation of the application on the user electronic device 220 and perform basic configuration of the application. After completion of the installation process, at block 455 the app management software 230 may replace all teaser icons of a newly installed application with the original icons of the application. Thereafter, at block 460 the app management software 230 closes the teaser of the application 100 and opens the application itself.

All application metadata downloaded from the server 210 during the installation of the app management software 230 is stored on the electronic device 220. This metadata can be used by both the app management software 230 and the operating system of the electronic device 220. In accordance with various aspects of the disclosure, the metadata may be used when the operating system receives a request to open a file of a format that none of the applications installed on the electronic device can support.

In this case, the operating system may scan preference files of all applications installed on the electronic device 220 to find preference files of applications that support the required file format. In accordance with various aspects of the present disclosure, preference files of teasers of applications include data of the preference files of the original applications. Therefore, the operating system may use a teaser of an application to open file formats that are listed in their preference files.

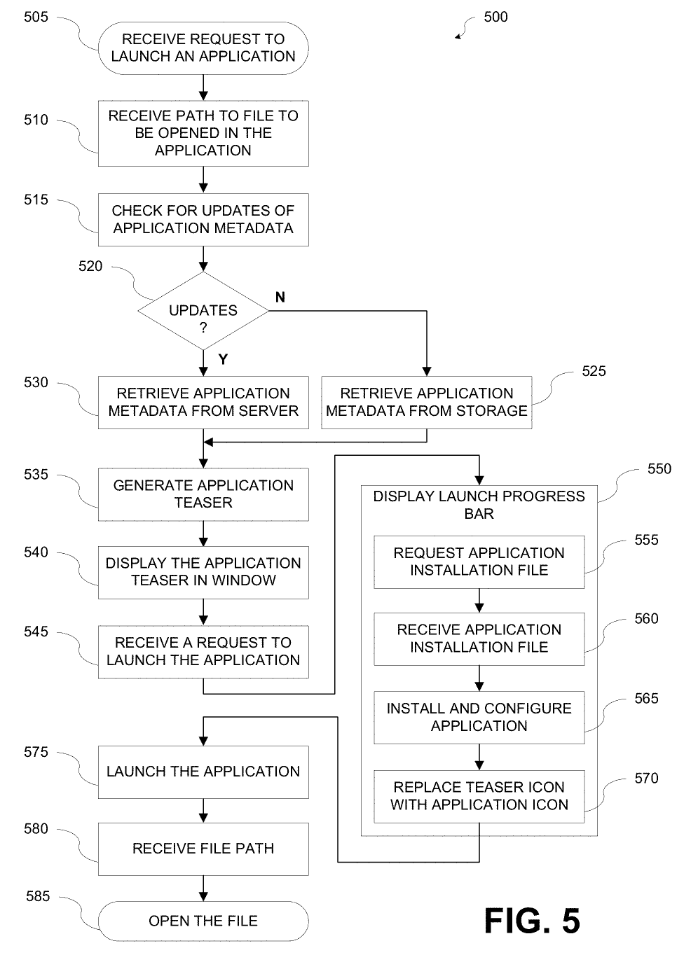

FIG. 5 is a flowchart illustrating a method 500 for opening a file in an application that is launched from a teaser of an application in accordance with various aspects of the present disclosure. Referring to FIGS. 1, 2, and 5, at block 505, the app management software 230 may receive a request to launch an application and a path to the file to be opened. For example, the user may input a command including a name of a file to be opened on a user interface device of the electronic device 220. After receiving the request, at block 515 the app management software 230 may send a request to the server 210 to check for the updates of the application metadata. At block 520, the server 210 may determine whether updates of the application metadata are available. In response to determining that updates are not available (520—N), at block 525 the app management software 230 may retrieve application metadata from local storage of the user electronic device 220. In response to determining that updates are available (520—Y), at block 530 the app management software 230 may retrieve application metadata from the server 210. At block 535, the app management software 230 may generate a teaser of an application 100. At block 540, the app management software 230 may show the teaser of the application 100 on the display 250 of the electronic device 220. At block 545, the app management software 230 may receive a request to launch the application. For example, the user may input a command (e.g., activate the Open button 150) on a user interface device of the electronic device 220. Application download, installation, and launch may be performed sequentially and automatically after using a prescribed user interface control (i.e., the Open button 150).

At block 550, the teaser of an application 100 may display a progress indicator indicating the progression of the launch process. In accordance with various aspects of the present disclosure, the progress indicator may remain displayed in the teaser of an application 100 until the application is opened. One of ordinary skill in the art will appreciate that the progress of download, installation, and/or launch process can be displayed in any other way without departing from the scope of the present disclosure. In accordance with various aspects of the present disclosure, when the user clicks the Open button 150, the Open button 150 may change to a Stop button, which the user may click to cancel the on-going process.

At block 555 the app management software 230 may send a request to the server 210 to get the application installation file. At block 560, the installation file may be downloaded. For example, the app management software 230 may download the application installation file to the user electronic device 220 from the server 210. At block 565, the application may be installed and configured. For example, the app management software 230 may automatically starts installation of the application on the user electronic device 220 and perform basic configuration of the application. After completion of the installation process, at block 570 the app management software 230 may replace all teaser icons of a newly installed application with the original icons for the application. At block 580, the application may receive the file path from the app management software 230 and at block 585 the app management software 230 may open the file.

A teaser of an application can be moved from one electronic device to another one, like any regular application (or its installation files). However, according to the preferred implementation of the invention, if a user tries to open a teaser of an application on an electronic device where no app management software is installed, it returns only a notification offering to download the app management software. Alternative implementations of the invention may not work without an app management system, or they may return other notifications or provide some additional functionality that is not covered by the preferred embodiment.

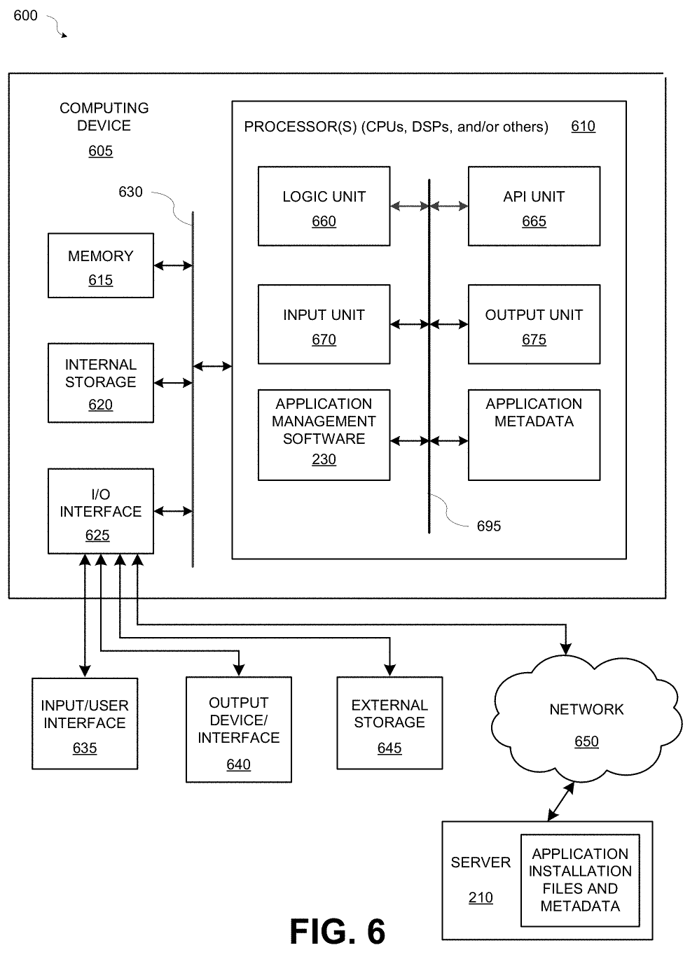

FIG. 6 is a block diagram illustrating an example computing environment 600 with an example computing device 605 associated with the application distribution environment in accordance with various aspects of the present disclosure. The computing environment 600 may include a computing device 605 (e.g., the user electronic device 220) and a server 680. Application installation files and application metadata may be stored on the server 680. The server 680 may communicate with the computing device 605 via a network 650.

The computing device 605 may be, for example, but not limited to, the user electronic device 220. The computing device 605 may include one or more processing units, cores, or processors 610, memory 615 (e.g., RAM, ROM, and/or the like), internal storage 620 (e.g., magnetic, optical, solid state storage, and/or organic), and/or I/O interface 625, any of which can be coupled on a communication mechanism or bus 630 for communicating information or embedded in the computing device 605. The memory 615 and/or the internal storage 620 may be configured to store operating systems and/or application programs for operation of the computing device 605 that are executed by the one or more processing units, cores, or processors 610, as well as to store application data and user data.

The computing device 605 may be communicatively coupled to an input/user interface 635 and an output device/interface 640. Either one or both of the input/user interface 635 and the output device/interface 640 may be a wired or wireless interface and can be detachable. The input/user interface 635 may include any device, component, sensor, or interface, physical or virtual, which can be used to provide input (e.g., buttons, touch-screen interface, keyboard, a pointing/cursor control, microphone, camera, braille, motion sensor, optical reader, and/or the like). The output device/interface 640 may include a display, television, monitor, printer, speaker, braille, or the like. In some example implementations, the input/user interface 635 and the output device/interface 640 may be embedded with or physically coupled to the computing device 605. In other example implementations, other computing devices may function as or provide the functions of the input/user interface 635 and the output device/interface 640 for the computing device 605.

Examples of the computing device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

The computing device 605 can be communicatively coupled (e.g., via the I/O interface 625) to external storage 645 and a network 650 for communicating with any number of networked components, devices, and systems, including one or more computing devices of the same or different configuration. The computing device 605 or any connected computing device can be functioning as, providing services of, or referred to as a server, client, thin server, general machine, special-purpose machine, or another label.

The I/O interface 625 may include wireless communication components (not shown) that facilitate wireless communication over a voice and/or over a data network. The wireless communication components may include an antenna system with one or more antennae, a radio system, a baseband system, or any combination thereof. Radio frequency (RF) signals may be transmitted and received over the air by the antenna system under the management of the radio system.

The I/O interface 625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in the computing environment 600. The network 650 can be any network or combination of networks (e.g., the Internet, local area network, wide area network, a telephonic network, a cellular network, satellite network, and the like).

The computing device 605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

The computing device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

The processor(s) 610 can execute under any operating system (OS) (not shown), in a native or virtual environment. One or more applications may be deployed that may include a logic unit 660, an application programming interface (API) unit 665, an input unit 670, and an output unit 675. The application management software 230 may be deployed on the computing device 605 and may cause the various units of the computing device 605 to execute one or more processes shown in FIGS. 3, 4, and 5. The described units and elements can be varied in design, function, configuration, or implementation and are not limited to the descriptions provided.

In some example implementations, when information or an execution instruction is received by API unit 665, it may be communicated to one or more other units (e.g., the logic unit 660, the input unit 670, and/or the output unit 675). For example, after input unit 670 has received input from a user, such as an instruction to launch an application or other such user interaction for an application managed by the application management software 230, input unit 670 may use API unit 665 to communicate a launch notification to the application management software 230

In some instances, logic unit 660 may be configured to control the information flow among the units and direct the services provided by the API unit 665, the input unit 670, and the output unit 675. For example, the flow of one or more processes or implementations may be controlled by logic unit 660 alone or in conjunction with API unit 665.

The methods 300, 400, and 500, respectively, may be embodied on a non-transitory computer readable medium, for example, but not limited to, the memory 615, the internal storage 620, or other non-transitory computer readable medium known to those of skill in the art, having stored therein a program including computer executable instructions for making a processor, computer, or other programmable device execute the operations of the methods.

The example implementations may have various benefits and advantages. For example, but not by way of limitation, enhanced tracking of the fact of application usage to enable more equitable revenue sharing among developers of software managed by the application delivery.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A teaser of an application for displaying information about an application available for installation on an electronic device, the teaser of an application comprising:
application metadata retrieved from a storage of the electronic device;
a window configured to provide the application metadata retrieved from the storage in at least one of textual and graphical format on an output device; and
an interface control provided in the teaser of the application, the interface control configured to sequentially start download, validation, installation, and launch of the application available for installation provided in the teaser of the application.

2. The teaser of an application of claim 1, wherein the application metadata comprises:
an application name, an application release version, an application release date, a description of application capabilities and features, an application icon, an application motto, a name of a software developer, a product page uniform resource locator (URL), at least one screenshot, and a video file.

3. The teaser of an application of claim 1, further comprising a progress indicator provided in the teaser of the application,
wherein the progress indicator is invoked by the interface control that sequentially starts the download, installation, and launch of the application, and
wherein the progress indicator provides a progression of an on-going process started with the interface control.

4. The teaser of an application of claim 1, wherein an application motto provides one of a main idea or intended usage of the application.

5. The teaser of an application of claim 1, further comprising functionality for in-application purchases functionality and/or an embedded store.

6. The teaser of an application of claim 1, wherein the display comprises a window on an output device.

7. A method for previewing and launching an application available for installation on an electronic device, the method comprising:
receiving via an interface a request to provide a teaser of the application having application metadata stored in a storage on the electronic device;
contacting, by the electronic device, a server to determine whether updates are available for the application metadata;
in response to determining that updates are available for the application metadata, downloading updated application metadata from the server and updating the application metadata stored on the electronic device;
generating the teaser of the application based on the updated application metadata in the window on a display of the electronic device;
receiving via the interface a request to launch the application provided in the teaser of the application;
requesting from the server by the electronic device an application installation file corresponding to the application of the teaser of the application;
receiving from the server the requested application installation file;
installing the application on the electronic device;
launching the installed application; and
closing the teaser of the application after launching of the installed application.

8. The method of claim 7, wherein the generating a teaser of the application comprises:
providing application metadata in at least one textual and graphical format in the teaser of the application; and
providing an interface control in the teaser of the application.

9. The method of claim 8, wherein the interface control is configured to sequentially start download, installation, and launch of the application provided in the teaser of the application.

10. The method of claim 7, wherein the application metadata comprises:
an application name, an application release version, an application release date, a description of application capabilities and features, an application icon, an application motto, a name of a software developer, a product page uniform resource locator (URL), at least one screenshot, and a video file.

11. The method of claim 7, further comprising receiving a request to provide the teaser of an application to open a file of a format that applications installed on the electronic device are not configured to open.

12. The method of claim 11, further comprising opening the file in an application that has been installed and launched via the teaser of the application.

13. The method of claim 7, wherein the receiving via an interface a request to provide a teaser of the application further comprises at least one of:
double-clicking on a teaser icon;
clicking on a teaser icon;
choosing a corresponding command from a shortcut menu associated with a teaser icon;
hovering a pointer over a teaser icon; and
executing an internal search within the storage of the electronic device.

14. The method of claim 13, wherein the teaser icon of the application available for installation on the electronic device appears as an icon of an associated application.

15. The method of claim 13, wherein the teaser icon of the application available for installation on the electronic device differs in appearance from an icon of an associated application.

16. The method of claim 7, wherein the generating a teaser of the application comprises generating a window on a display of the electronic device.

17. A non-transitory computer-readable medium having stored therein instructions for causing one or more processors to perform operations comprising:
storing in a storage of an electronic device metadata of an application available for installation on the electronic device;
providing at least one teaser icon of the application available for installation on the electronic device at a location on a display of the electronic device where icons of installed applications are provided;
receiving via an interface a request to provide a teaser of an application having application metadata stored in the storage on the electronic device;
contacting, by the electronic device, a server to determine whether updates are available for the application metadata;
in response to determining that updates are available for the application metadata, downloading updated application metadata from the server and updating the application metadata on the electronic device;
generating a teaser of the application based on the updated metadata on the display of the electronic device;
receiving via the interface a request to launch the application provided in the teaser of the application;
requesting from the server by the electronic device an application installation file corresponding to the application of the teaser of the application;
receiving from the server the requested application installation file of the application;
installing the application on the electronic device;
launching the installed application; and
closing the teaser of the application after launching of the installed application.

18. The non-transitory computer readable medium having stored therein instructions as defined in claim 17, wherein the generating a teaser of an application comprises:
providing application metadata in at least one textual and graphical format in the teaser of the application; and
providing an interface control in the teaser of the application.

19. The non-transitory computer readable medium having stored therein instructions as defined in claim 18, wherein the interface control is configured to sequentially start download, installation, and launch of the application provided in the teaser of the application.

20. The non-transitory computer readable medium having stored therein instructions as defined in claim 17, wherein the application metadata comprises:
an application name, an application release version, an application release date, a description of application capabilities and features, an application icon, an application motto, a name of a software developer, a product page uniform resource locator (URL), at least one screenshot, and a video file.

21. The non-transitory computer readable medium having stored therein instructions as defined in claim 17, the instructions further including receiving a request to provide a teaser of an application to open a file of a format that applications installed on the electronic device are not configured to open.

22. The non-transitory computer readable medium having stored therein instructions as defined in claim 21, the instructions further including opening the file in an application that has been installed and launched via the teaser of the application.

23. The non-transitory computer readable medium having stored therein instructions as defined in claim 17, wherein the receiving via the interface a request to provide the teaser of the application further comprises at least one of:
double-clicking on a teaser icon;
clicking on a teaser icon;
choosing a corresponding command from a shortcut menu associated with a teaser icon;
hovering a pointer over a teaser icon; and
executing an internal search within the storage of the electronic device.

24. The non-transitory computer readable medium having stored therein instructions as defined in claim 17, the instructions further including generating the teaser of the application based on a strict unified pattern and includes customized metadata of each application.

25. The non-transitory computer readable medium having stored therein instructions as defined in claim 17, wherein generating a teaser of the application comprises generating a window on a display of the electronic device.
